(19) United States
(12) Patent Application Publication
(10) Pub. No.: US 2013/0257753 A1
(43) Pub. Date: Oct. 3, 2013

(54) Modeling Actions Based on Speech and Touch Inputs

(71) Applicants: Anirudh Sharma, Bangalore (IN); Sriganesh Madhvanath, Bangalore (IN)

(72) Inventors: Anirudh Sharma, Bangalore (IN); Sriganesh Madhvanath, Bangalore (IN)

(21) Appl. No.: 13/438,646

(22) Filed: Apr. 3, 2012

(51) Int. Cl. G06F 3/041

(52) U.S. Cl. 345/173

(57) ABSTRACT

A method for modifying a computer generated three dimensional model, includes performing a particular modeling action on the model in response to a speech input; performing another modeling action on the model in response to a multi-touch input on a display screen; and displaying said model as so modified on the display screen.

### BACKGROUND

Generally, before a prototype is manufactured in a machine shop, the prototype is first modeled with a computer program. Typically, the program will display the modeled prototype on a display screen, and a user may interact with or modify the model through use of keyboard and mouse inputs.

Often, modeling programs are designed for sophisticated users who are specifically trained to use such programs. These users may become more proficient with the program as they gain additional modeling experience.

In the early concept stage of prototyping, computer generated models may undergo substantial changes. In fact, such early models may be specifically intended for computer aided presentations with a purpose to receive feedback on the modeled concept. Such conceptual presentations rarely need the model to be designed to the precise tolerances needed for creating a physical prototype in the machine shop.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an illustrative system for controlling a modeling program, according to principles described herein.

FIG. 2 is a diagram of an illustrative modeling action, according to principles described herein.

FIG. 3 is a diagram of an illustrative modeling action, according to principles described herein.

FIG. 4 is a diagram of an illustrative modeling action, according to principles described herein.

FIG. 5 is a diagram of an illustrative method for controlling a modeling program, according to principles described herein.

FIG. 6 is a diagram of an illustrative system for controlling a modeling program, according to principles described herein.

FIG. 7 is a diagram of an illustrative processor, according to principles described herein.

FIG. 8 is a diagram of illustrative speech inputs, according to principles described herein.

FIG. 9 is a diagram of illustrative touch inputs, according to principles described herein.

FIG. 10 is a diagram of an illustrative touch input device, according to principles described herein.

FIG. 11 is a diagram of an illustrative touch input device, according to principles described herein.

FIG. 12 is a diagram of an illustrative touch input device, according to principles described herein.

FIG. 13 is a diagram of an illustrative flowchart for performing a modeling action, according to principles described herein.

FIG. 14 is a diagram of an illustrative flowchart for performing a modeling action, according to principles described herein.

### DETAILED DESCRIPTION

The present specification describes principles including, for example, a method for modifying an electronic, computer-generated model. Examples of such a method may include performing modeling actions to modify the existing model in response to speech or touch input on a touch-sensitive pad and displaying the model as modified on a display screen. As used herein, a “modeling action” is any action to create, modify, display or change the display of a model, particularly an electronic, computer-generated model.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

FIG. 1 is a diagram of an illustrative system (100) for controlling a modeling program, according to principles described herein. In some examples, the modeling program allows a user to create, view, and/or modify an electronic, computer-generated model. The model may be a three dimensional model that may be used to illustrate conceptual ideas for products or prototypes. Also, in some examples, the model may have enough precision for manufacturing applications. The computer program may include functionality that converts the components of the computer generated model into drawing sheets that may be used in a machine shop.

In some examples, the modeling program may be integrated into a subtractive manufacturing process, an additive manufacturing process, other manufacturing process, or combinations thereof. Additive manufacturing processes may include three dimensional printing, laser based additive manufacturing, electron beam melting, other three dimensional manufacturing methods, or combinations thereof. Subtractive manufacturing methods may include the use of lathes, drills, computer numeral controlled machines, routers, saws, mills, grinders, or combinations thereof. In some examples, the models may be built through molding, extrusion, and/or casting. In some examples, the modeling program may be a three dimensional modeling program or a two dimensional modeling program.

The system (100) may include a display screen (101) for displaying the model. The display screen may have a digital panel that utilizes active or passive pixel matrixes. In some examples, the model may be displayed on the screen by projecting an image.

The system (100) may have a plurality of inputs. In some examples, the system has a speech input device (102), such as a microphone. The speech input device (102) may be in communication with a processor that recognizes speech commands from audible sounds. The processor may additionally process the commands and perform modeling actions based on the speech input.

The system (100) may also have a touch input device (103), such as a touch-sensitive screen or pad. In the example of FIG. 1, the display screen (101) is incorporated into the touch input device (103) to provide a touch-sensitive screen. In this example, a user may physically touch the display screen to provide input to the modeling program to execute a modeling action. For example, the touch input device may have the capability of optically or electrically identifying the location of a user's physical contact with the display screen such that the program can map each contact's location on the display with respect to the displayed model. Thus, in such an example, the user may intuitively use his or her fingers to virtually touch the displayed model and manipulate the model with physical contact with the screen (101).

A touch input device may be a device that recognizes when it is touched directly by a user. For example, a touch input device may be a touch screen that recognizes physical contact from a human finger. The recognition of the touch may be from a mechanical force applied by the finger, an electrical characteristic of the finger's contact, or an optical characteristic of the finger's contact. In some examples, the touch input device may recognize when it is touched by a person wearing a glove because the finger's mechanical, electrical characteristics, or optical characteristics may be sensed through the glove or the glove may be designed to provide a characteristic that the touch input device is capable of sensing. A keyboard is not considered a touch input device as defined and used herein.

A multi-touch input device may be a touch input device that has the ability to sense and distinguish between multiple touch contacts at substantially the same time. The discrete contacts may send discrete signals to a processor that may time stamp and interpret each signal to interpret touch commands. Multiple touch contacts may include multiple fingers making contact at different locations on a surface of a display screen. These multiple contacts may be moved across the surface of the screen in different directions, moved in similar directions, moved at different speeds, applied with different pressures, or combinations thereof.

In some examples, a multi-touch input may include holding a first contact substantially stationary with respect to the touch input device and moving a second contact along the surface of the touch input device. In some examples, a multi-touch device may recognize different commands when a first contact is held stationary with respect to the touch device and a second contact is tapped, varies its pressure, is made for a different amount of time than the first contact, or combinations thereof. In some examples, a multi-touch input allows for a large variety of inputs. Further, multi-touch input may be intuitive for a user.

The display screen (101) may be supported by at least one support (104). The support may have at least one mechanism (105) that allows the display screen to be adjusted to a comfortable ergonomical tilt with respect to the support, floor, user, or combinations thereof. In some examples, a user may desire the display screen to form a 45 degree tilt angle with respect to the floor. The mechanism (105) may include a guide, a hinge, an axle, locking fixtures, or combinations thereof. The tilt angle may be sufficient for a user to control the modeling program through touch and/or speech inputs while standing or sitting.

While the example of FIG. 1 depicts the system (100) with supports (104) and an adjustable mechanism (105), the system (100) may incorporate other features. For example, the system (100) may be incorporated into a mobile device, like an electronic tablet, phone, or watch. In some examples, the display screen may be incorporated directly into a wall, podium, table top, instrument panel, vehicle, computer, laptop, large screen device, drafting table, or combinations thereof.

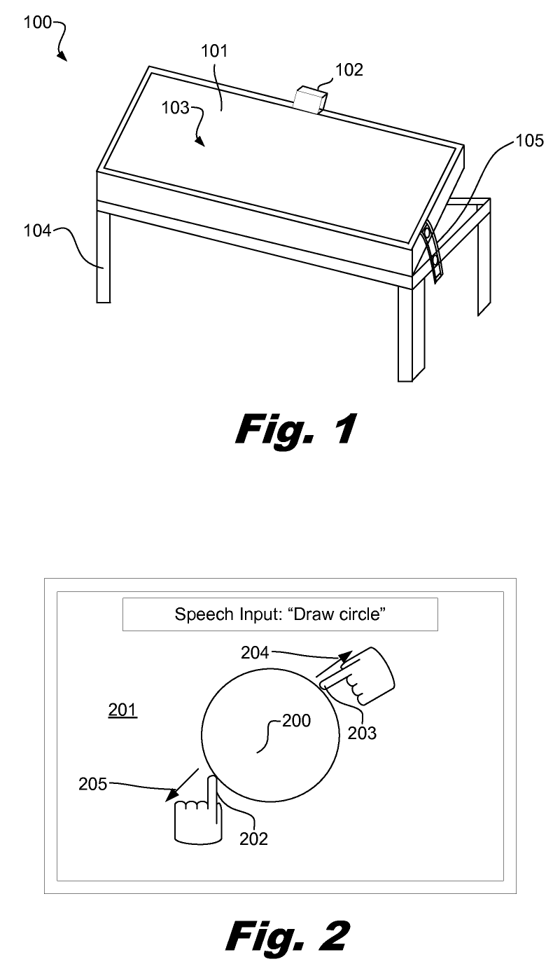

FIG. 2 is a diagram of an illustrative modeling action, according to principles described herein. In this example, a speech input is depicted in the diagram for illustrative purposes. A user may instruct the modeling program to draw a circle (200) by speaking the words, “Draw circle.” After such a speech input, the modeling program may perform a modeling action of displaying a circle on the display screen (201). The user may use a multi-touch input to modify the size of the circle while the program remains in a “draw circle” mode. The multi-touch input may be generated by a user physically contacting the display screen (201) with at least two fingers (202, 203) and moving the fingers in different directions (204, 205). In some examples, the circle (200) may increase in size if the different directions move the fingers away from one another, and the circle may decrease in size if the different directions move the fingers closer together. In some examples, the contacts with the display screen must contact coordinates of the screen upon which the circle is displayed. In alternative examples, the contacts may be formed with any portion of the display screen to effectively execute the modeling action of sizing the circle.

Further, in some examples, while the modeling program remains in the “draw circle” mode, the user may move the location coordinates of the circle by making a single physical contact with the screen and dragging the contact across the surface of the screen to a desired location.

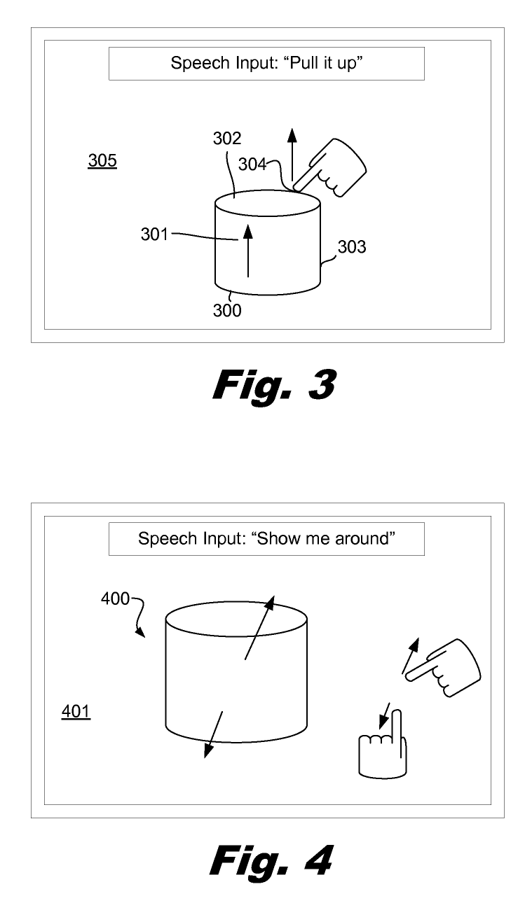

In the example of FIG. 3, the user gives a speech command, “pull it up,” to switch the modeling mode. In this mode, the user turns an original, two dimensional circle (300) into a three dimensional cylinder (301) by creating a second circle (302) superimposed over the original circle (300). The user may instruct the modeling program to move the second circle (302) a specified distance from the original circle (300) which may create a length (303) of the cylinder (301). The user may instruct the program to move the second circle (302) by making a single physical contact (304) with the display screen (305) at a location that displays a portion of the second circle (302) and moving the contact to the desired length. In some examples, other touch commands may be specifically available under the “pull it up” mode.

In the example of FIG. 4, the speech input is “show me around,” which switches the program's mode. In some examples, under this mode, the user may use multiple touch contacts to zoom in or away from the model (400). Also, in some examples, under the “show me around” mode, a single touch contact may rotate the model (400) in the direction that the contact is dragged along a surface of the display screen (401).

Gesture inputs, such as hand gesture inputs, may be extended to the (non-touch) space above the touch surface. These inputs may be captured using gesture input devices, like cameras or other sensors placed below or above the surface. These inputs may be used to instruct the program to do a plurality of modeling actions by themselves or in combination with touch inputs. In some examples, similar or the same touch or gesture inputs used in different modeling modes will send different commands to the program. In some examples, non-touch inputs may clear the display, modify the display, zoom in and out of the display, pull up a three dimensional image of a model, other modeling actions, and combinations thereof.

The combination of a touch input, which may be a multi-touch input, and a speech input may allow a novice user to intuitively control the modeling program. Further, the combination of touch and speech inputs may reduce or eliminate the desire for icons on the display screen or for keypads. In some examples, the combination of speech and touch may allow a user to continually devote their attention to the model instead of searching through command icons indexed on or off the display screen. As a consequence, a user may experience less frustration while using the modeling program, and experienced users may use the program more quickly and with less distraction.

In some examples, the model may be displayed on a two dimensional display. In other examples, the display may be capable of rendering models in three dimensions, using an appropriate 3D display technology which may require the user to wear active or passive glasses to view the three dimensional model. In examples where three dimensional displays are used, the user may give speech and touch commands to manipulate the model and perform other modeling actions. Gaze tracking technology, multi-view display technology, other three dimensional display technology, and combinations thereof may be used to display a three dimensional model.

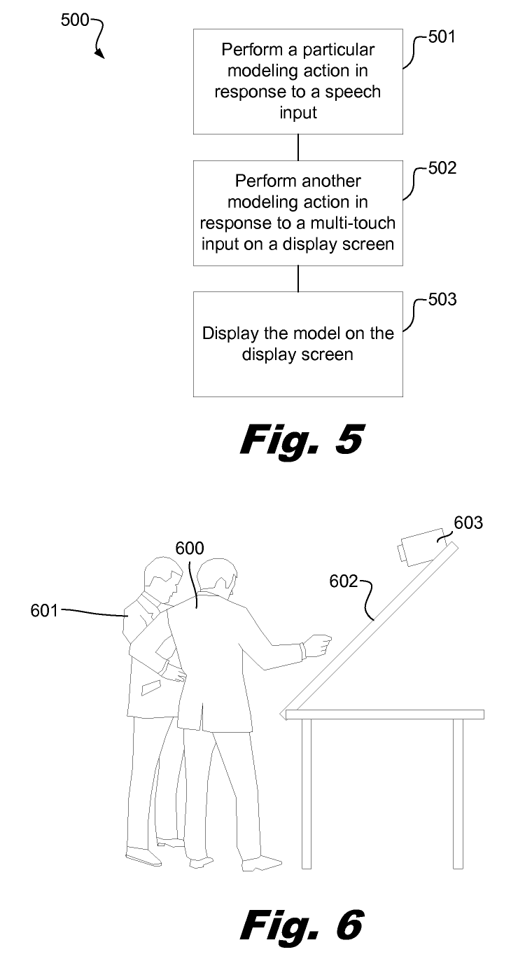

FIG. 5 is a diagram of an illustrative method (500) for controlling a modeling program, according to principles described herein. In this example, the method include performing (501) a particular modeling action in response to a speech input, performing (502) another modeling action in response to a multi-touch input on a display screen, and displaying (503) a model of the program on the display screen. While performing a modeling action in response to the speech input is listed first in the method, the method may contain no predetermined sequence. For example, performing (502) the modeling action in response to a multi-touch input or displaying (503) the model may occur before performing a speech responsive modeling action. In some examples, two or more of the actions in the method may be performed simultaneously. As in the preceding examples of FIGS. 2 and 3, the touch input may correspond to, and follow, the speech input. For example, the user may use speech input to indicate an operating mode, e.g., “draw circle” and use touch input to provide corresponding instructions for sizing or placing the circle.

In some examples, the modeling actions include changing a view of the display, modifying a model displayed in the screen, switching modeling modes, turning the system off or on, turning the system to a power saver mode, saving changes, refreshing the model, showing a sectional view of the model in the display, zooming into or away from the model, emailing the model file, creating drawing specification sheets for a machine shop based on the model, deleting a model component, clearing the display, undoing changes, importing files from another program, exporting files to another program, selecting colors, selecting line thickness, selecting line style, filling in empty space, selecting model components, annotating model components, searching for model components, naming model components, specifying dimensions of model components, sizing model components, rotating model components, switching between model layers, rotating model components, printing the model, or combinations thereof.

In some examples, the multi-touch input includes moving a first contact across the display screen in a first direction and moving a second contact in a second direction across the display screen. Further, performing a second modeling action in response to a multi-touch input may include integrating touch inputs from at least two contacts made with the display screen.

In some examples, responding to a speech input may include distinguishing a speech command from ambient noise. For example, the modeling system may filter out noises such as conversations between nearby individuals uninvolved with modeling and noises from doors, windows, sandwich wrappers, passing trains, other non-command sources, and combinations thereof. In some examples, the system may respond to only authorized voices. For example, a user may wish to prevent those with whom he or she is showing a model from unintentionally giving the system a speech command. In such an example, the user may activate a voice recognition mechanism or other mechanism that may prevent others from giving commands.

In some examples, a camera in communication with a processor of the system may be positioned to read the lips of one or multiple users. The processor may compare auditory inputs with lip movement when determining if a sensed sound is intended to be a speech command or if the command came from an authorized user.

In some examples, a speech command may be preceded with a speech or touch input intended to alert the system that the following sound is intended to be a speech input. For example, the user may state the word, “computer” or an assigned name for the system before giving a speech command. In other examples, other terms or sounds may be used.

FIG. 6 is a diagram of an illustrative system for controlling a modeling program, according to principles described herein. In this example, a user (600) may be explaining a concept to another individual (601) by using a model displayed in the display screen (602). A camera (603) may be oriented to record lip movements of the user (600) to distinguish auditory inputs of the user (600) and other individual (601). For example, auditory input that sounds like a speech command that originated from the other individual (601) may be disregarded by the system because the system may be programmed to only accept auditory input that matches the lip movement of the authorized user (600). In some examples, the system may be programmed to accept speech commands from multiple individuals. In some of these examples, a camera (603) may still be used to identify lip movement to distinguish between speech commands and ambient noise.

In other examples, the user (600) may be using the modeling program by himself or herself, and the lip movement is used to distinguish between auditory inputs from the user and other auditory sources sensed by the system. In some examples, the camera (603) may be the sole speech input device. In such examples, the system recognizes speech commands entirely through lip movement. In some examples, the visual input from a camera and auditory input from a microphone are integrated together to determine speech commands.

The system may be programmed to move the camera as desired to record lip movement. For example, the camera may change an orientation angle to switch between individuals discussing the model. In some examples, the program recognizes movement within the visual image recorded by the camera, but the program may be programmed to only determine lip movement for individuals close to the display screen or individuals standing in certain locations. In some examples, multiple cameras may be used to capture lip movement from multiple angles or for multiple people. Multiple cameras may be useful for users who pace or move around while using the modeling program. In some examples, a user may be presenting the concept to a large audience and may at times face away from the display screen to face the audience. In such examples, cameras may be directed at the user from multiple angles.

Further, another speech input device may be an electroencephalograph, or other brain computer interface, used to measure brain activity of individuals. Such a device may recognize speech inputs of individuals who have a speech impairment, like stuttering. Also, such a speech input device may serve those who are mute, have vocal cord damage, have a vocal cord deformity, have other damage or deformities that affects a user's ability to speak, or combinations thereof. An electroencephalograph may be used to measure brain activity that represents commands to the various organs used to produce speech even if those organs do not respond to those commands.

The speech input device may include any device used to detect speech. The device may measure acoustic vibrations, record visual movement, electrical signals, or other signals originating from a user to recognize speech commands.

In some examples, multiple users may interact with the modeling program at the same location or at remote locations. In examples, where users are at remote locations, the users may discuss the model and coordinate the interactions over communication devices such as phones, microphones, computer hardware, other communication devices, or combinations thereof. The system may distinguish between the users' commands and conversations. Further, in some examples, the users may both have the ability to use touch input and speech input to instruct the modeling program. In some examples, the system may give a single user the ability to command modeling actions at a time with touch input, speech input, or combinations thereof.

In some examples, the camera (603) may also be a gesture input device used to record gesture inputs.

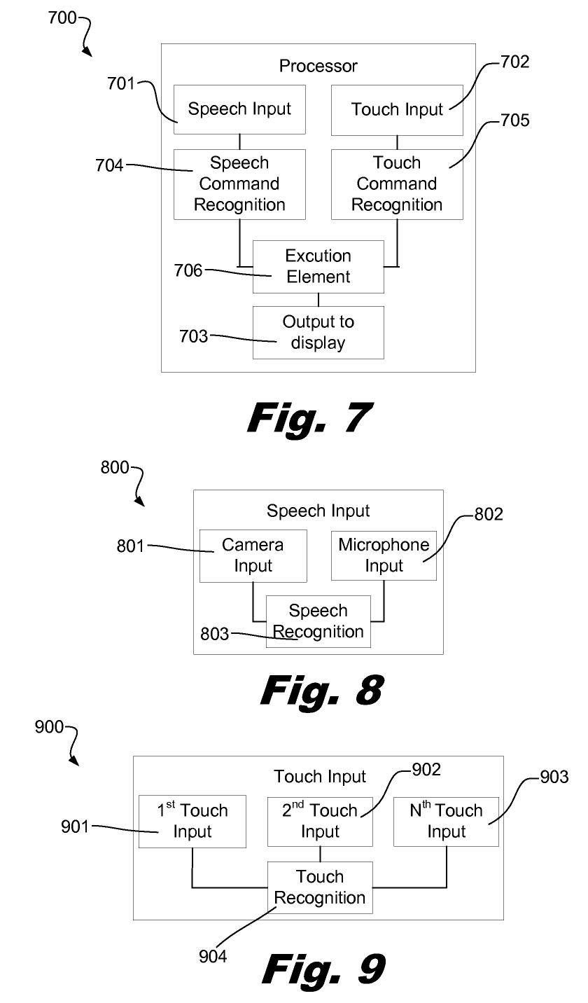

FIG. 7 is a diagram of an illustrative processor (700), according to principles described herein. In this example, the processor (700) may have a speech input (701), a touch input (702), and an output (703) to a display screen. The inputs (701, 702) may receive inputs from a user. The processor (700) may have a speech command recognition component (704) that determines whether the speech input is a command. If the speech command recognition (704) recognizes a speech command, the speech command recognition (704) may also determine which command the speech input represents. Additionally, the processor (700) may have a touch command recognition component (705) that determines whether a touch input is a command, and if so, what the command is.

The commands may be sent to an execution element (706) that executes commands from either recognition component (704, 705). In some examples, if the speech or touch command recognition (704, 705) determines that no command is intended from a received input, the recognitions (704, 705) may disregard the signal such that the execution element (706) is unaware of the received input. In some examples, when no command is recognized, the recognitions (704, 705) may send a “no action” command to the execution element (706). The execution element (706) may be in communication with the output (702), so that an executed command is viewable for a user.

FIG. 8 is a diagram of illustrative speech inputs, according to principles described herein. A processor's speech input (800) may be in communication with multiple input devices. For example, the processor's speech input may be in communication with a camera input (801) and/or a microphone input (802). In some examples, there may be multiple camera inputs and/or multiple microphone inputs. In some examples, other speech input devices may be used. A speech recognition component (803) may be used to integrate all of the speech inputs to determine if the inputs are commands and, if so, what the commands are.

FIG. 9 is a diagram of illustrative touch inputs, according to principles described herein. As described above, a processor's touch input (900) may be capable of distinguishing between multiple physical contacts with a touch input device. For example, a user may use first and second fingers to form a first and a second contact or touch inputs (901, 902) with a touch-sensitive display screen. In some examples, a user may use additional fingers to create additional contacts or touch inputs with the input device. Each additional touch input may be used to communicate specific commands to the modeling program. In the example of FIG. 9, an Nth touch input (903) is used to represent an unspecified number of touch inputs to illustrate that any number of touch inputs may be used according to the principles described herein. A touch recognition component (904) may be used to integrate all of the touch inputs to determine if the inputs are commands and, if so, what the commands are.

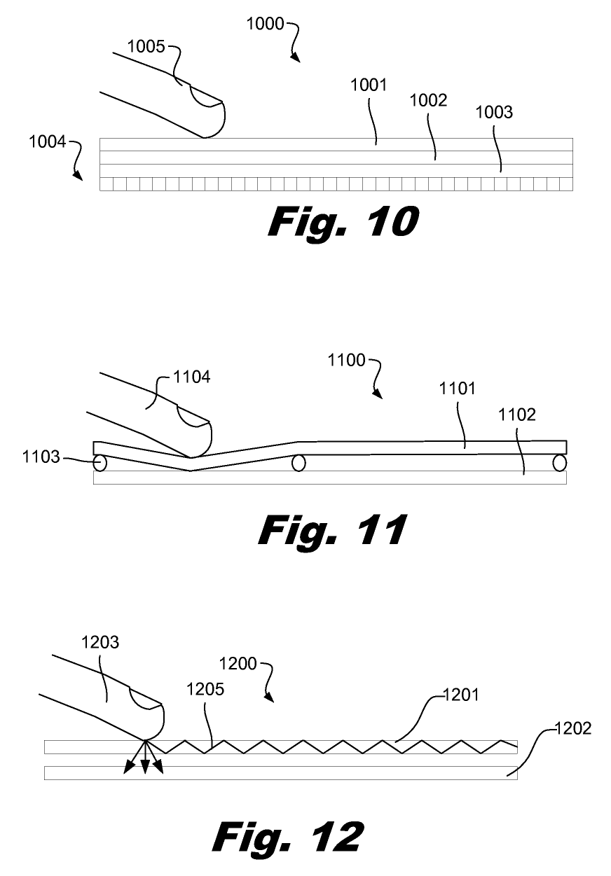

FIG. 10 is a diagram of an illustrative touch input device (1000), according to principles described herein. In this example, the touch input device (1000) has a protective layer (1001), which may be made of a transparent, electrically insulating material such as glass. Beneath the protective layer (1001), a first electrically conductive layer (1002) may have a plurality of electrically conducting layers arranged in rows. The first electrically conducting layer (1002) may be separated from a second electrically conducting layer (1003) by an insulating layer (1004). The second electrically conducting layer (1003) may have another plurality of electrical conductors arranged in columns that are ninety degrees offset from the rows of the first electrically conducting layer (1002). In such a manner, the rows and columns form discrete, identifiable intersections. Electrical current may be passed through the rows and columns of the conductive layers (1002, 1003) creating an electric field within the insulating layer (1004).

The electrical characteristics of a human finger (1005), when placed on the protective layer, form an additional electric field with the first conductive layer (1002). The creation of the second electric field affects the first electric field created in the insulating layer (1004) such that the first electric field is a measurably different, such as exhibiting a voltage drop. The measurable difference may be sensed on the row(s) and column(s) of the conductive layers (1002, 1003). Thus, the touch input device (1000) identifies the area of the protective layer in contact with the finger (1005). As a consequence, the single and multiple contacts made by a finger or other human part may ascertainable. In this manner, the touch input device (1000) may distinguish between multiple contacts as well as identify the areas of contacts. Thus, the touch input device may be able to identify when a finger is dragged across the touch input device's surface (1001), when fingers are dragged in different directions, when fingers are tapped on the surface (1001), when fingers are statically pressed against the surface (1001), when other contact inputs are made, or combinations thereof.

The protective layer (1001), the conductive layers (1002, 1003), and the insulating layer (1004) may be made of transparent materials, and a pixel matrix may be disposed beneath the second conductive layer. The pixel matrix may be used to form an image of the model, which is viewable through the transparent layers. Thus, a finger may make contact with an area of the protective layer that displays a portion of the model, and the coordinates of the area may be associated with the portion of the pixel matrix in such a manner that the touch input device may identify which parts of the model that the user intends to modify.

FIG. 11 is a diagram of an illustrative touch input device (1100), according to principles described herein. In this example, the touch input device (1100) may have a first and a second conductive layer (1101, 1102) separated by electrically insulating spacers (1103). A current may be passed through one of both of the electrically conductive layers. A finger (1104) may press the first electrically conductive layer (1101) such that first electrically conductive (1101) layer comes into contact with the second electrically conductive layer (1102) and causes a short between the layers (1101, 1102). In some examples, the electrically conductive layers (1101, 1102) are formed of rows and columns, such that the location of the short is identifiable. In this manner, a single or multiple contacts made by a user with an input device may be identifiable.

In some examples, a thin insulating material covers the first electrically conductive layer (1101) to prevent any electrical current from shorting to a human finger. In some examples, a pixel matrix may be positioned below transparent electrically conductive layers, such that a model image formed by the pixel matrix is viewable from a direction looking through the electrically conductive layers (1101, 1102).

FIG. 12 is a diagram of an illustrative touch input device (1200), according to principles described herein. In this example, a transparent layer (1201) may be positioned over a camera layer (1202), which may have at least one camera. The transparent layer may be made of a transparent acrylic material. Light (1205), such as infrared light, may be passed through the transparent layer (1201) in such a manner that the infrared light bounces in a predictable manner between boundaries of the transparent layer (1201). The light may be projected into the transparent layer (1201) with light emitting diodes positioned at edges of the transparent layer. When a human finger (1203) comes into contact with a surface of the transparent layer (1201), the light (1205) may be scattered in the contacted area. The scattered light may be sensed by the camera layer (1202) in such a manner that the contact area may be identifiable.

Other types of touch input devices may be used to identify the single and multiple touch inputs. A non-exhaustive list of technologies that may be employed to identify touch inputs may include capacitive technologies, projected capacitive technologies, mutual capacitive technologies, optical technologies, laser technologies, acoustic technologies, electrical resistive technologies, inductive technologies, triangulation technologies, other technologies, or combinations thereof.

In some examples, the image of the model may be projected onto a touch input device. In alternative examples, the image may be formed by a pixel matrix viewable through transparent components of a touch input device.

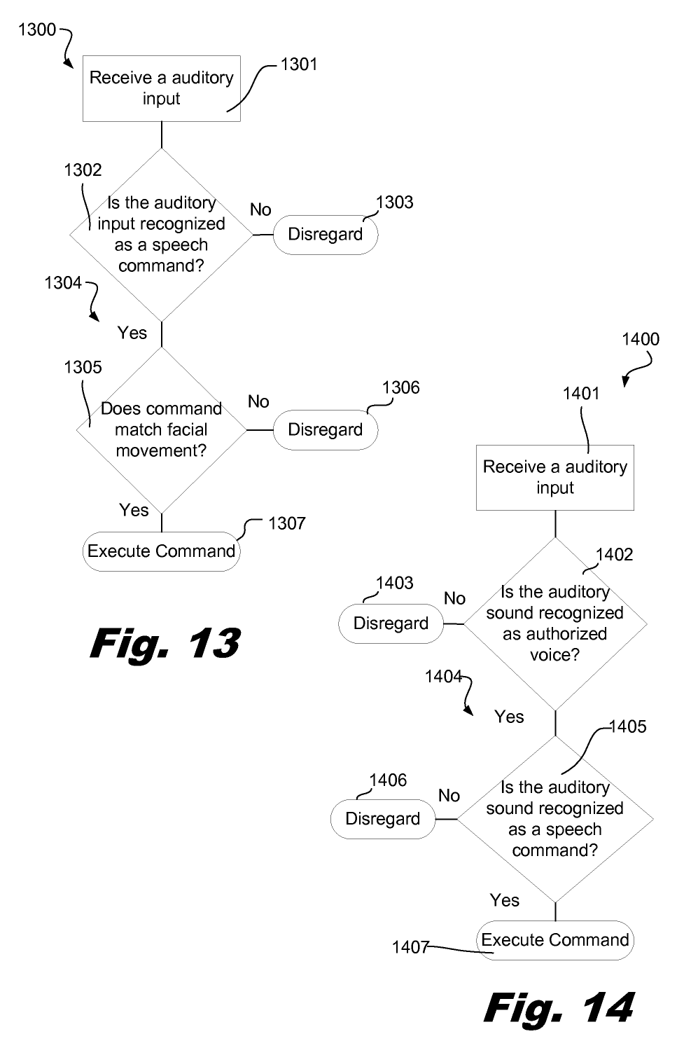

FIG. 13 is an illustrative flowchart (1300) for performing a modeling action, according to principles described herein. A system may receive (1301) an auditory input from a speech input device, such as a microphone. The system may determine whether (1302) the auditory input is recognized as a speech command. If not, the system may disregard (1303) the auditory input. If the auditory signal is recognized (1304) as a command, the system may determine (1305) if the command matches facial movement, like lip movement, of the user. If not, the system may disregard (1306) the command. If the system determines that the command matches the facial movement, the system may execute the command (1307).

FIG. 14 is a diagram of an illustrative flowchart (1400) for performing a modeling action, according to principles described herein. A system may receive (1401) an auditory input from a speech input device, such as a microphone. The system may determine whether (1402) the auditory input is recognized as a sound of an authorized voice. If not, the system may disregard (1403) the auditory input. If the auditory signal is recognized (1404) as being from an authorized user, the system may determine (1405) if the auditory input is a speech command. If not, the system may disregard (1406) the command. If the system recognizes the auditory input as a speech command, the system may execute the command (1407).

The preceding description has been presented only to illustrate and describe examples of the principles described. This description is not intended to be exhaustive or to limit these principles to any precise form disclosed. Many modifications and variations are possible in light of the above teaching.

What is claimed is:

1. A modeling system, comprising:
a speech input device;
a touch input device;
a display screen; and
a processor in communication with said speech input device, touch input device, and display screen; and
said processor programmed to:
perform a plurality of modeling actions in response to any of: at least one touch input and at least one speech input.

2. The system of claim 1, wherein said processor is also in communication with a gesture input device and programmed to perform at least one modeling action in response to a gesture input.

3. The system of claim 1, wherein said display screen is incorporated into said touch input device.

4. The system of claim 1, wherein said modeling actions are selected from the group consisting of changing a view of a display, modifying a model displayed on said display screen, switching modeling modes, or combinations thereof.

5. The system of claim 1, wherein said at least one touch input comprises multiple simultaneous contacts with said touch input device.

6. The system of claim 5, wherein said multiple simultaneous contacts with said touch input device comprise a first contact moving across said display screen in a first direction and a second contact moving across said display screen in a second direction.

7. The system of claim 1, where said display screen is secured to a support that accommodates said display screen being tilted to at least one acute angle.

8. A method for modifying a computer generated three dimensional model, comprising:
performing a particular modeling action on the model in response to a speech input;
performing another modeling action on the model in response to a multi-touch input on a display screen; and
displaying said model as so modified on said display screen.

9. The method of claim 8, wherein performing a particular modeling action in response to a speech input comprises receiving said speech input from a lip movement input.

10. The method of claim 8, wherein performing a particular modeling action in response to a speech input comprises distinguishing a speech command from ambient noise.

11. The method of claim 8, wherein performing a particular modeling action in response to a speech input comprises integrating speech inputs from at least two speech input devices.

12. The method of claim 8, wherein said modeling actions includes changing a view of said display, modifying a model displayed in said screen, switching modeling modes, or combinations thereof.

13. The method of claim 8, wherein said multi-touch input comprises a first contact moving across said display screen in a first direction and a second contact moving across said display screen in a second direction.

14. The method of claim 8, wherein performing another modeling action in response to a multi-touch input comprises integrating touch inputs from at least two contacts made with said display screen.

15. A computer program product, comprising:
a tangible computer readable storage medium, said computer readable storage medium comprising computer readable program code embodied therewith, said computer readable program code comprising:
computer readable program code to perform three dimensional modeling actions based on input from speech inputs and multi-touch inputs; and
computer readable program code to display said modeling actions on a display screen.
